(19) United States
(12) Patent Application Publication
(10) Pub. No.: US 2024/0152528 A1
(43) Pub. Date: May 9, 2024

(54) DISTRIBUTING MANAGEMENT OF DATA MANAGEMENT IN A DISTRIBUTED DIRECTORY SYSTEM

(71) Applicant: Microsoft Technology Licensing, LLC, Redmond, WA (US)

(72) Inventors: Juanya Davon Williams, Alpharetta, GA (US); Vladimir Vladimirovich Grebenik, Redmond, WA (US); Ruta Yeshwant Vaidya, San Jose, CA (US); Adolfo Francisco Ibarra Landeo, Lima (PE); Illary Huaylupo Sánchez, San José (CR); Gabriel Torres Peña, Bogotá (CO); Gokay Kadir Hurmali, Redmond, WA (US); Angus David Leeming, Exeter (GB); Dmitri Gavrilov, Redmond, WA (US)

(21) Appl. No.: 17/980,442

(22) Filed: Nov. 3, 2022

(51) Int. Cl. G06F 16/27; G06F 16/23; G06F 16/2455

(52) U.S. Cl. CPC G06F 16/27; G06F 16/2365; G06F 16/24552

(57) ABSTRACT

The present disclosure relates to utilizing a distributed data management system to provide improved data management, redundancy, and reliability in distributed directory systems. To illustrate, a distributed data management system improves existing distributed directory systems by relocating and distributing the management of data records from a centralized cache device to the backend storage partition devices. In this manner, the backend storage partition devices become responsible for automatically pushing data record metadata and changes to the centralized cache device, which only passively redirects the incoming requests to the proper backend storage partition devices. Additionally, the backend storage partition devices automatically resolve conflicts and restore lost data if the centralized cache device or a backend storage partition device suffers from faults or device failures.

### BACKGROUND

A distributed directory system is a system environment in which data is partitioned across multiple directory servers. Commonly, a centralized directory server controls the management of data by assigning and tracking which partitioned directory server will hold a given piece of data. Also, the centralized directory server fields incoming requests for data and distributes the requests to the proper partitioned directory server to return results to the requesting client device. Often, partitioned directory servers are separated geographically such that requests are fulfilled by the nearest partitioned directory server.

Despite advances made with modern-day distributed directory systems, these existing computer systems still face several technical shortcomings that result in inefficient, inaccurate, and inflexible computer operations, particularly in the area of data management and managing data records in distributed directory systems.

### BRIEF DESCRIPTION OF THE DRAWINGS

The detailed description provides one or more implementations with additional specificity and detail through the use of the accompanying drawings, as briefly described below.

FIGS. 1A-1B illustrate example environments showing components of a distributed directory system in accordance with one or more implementations.

FIG. 2A illustrates an example sequence diagram for implementing the distributed data system to add data records to the distributed directory system in accordance with one or more implementations.

FIG. 2B illustrates an example sequence diagram for implementing the distributed data system to retrieve data records in accordance with one or more implementations.

FIG. 3 illustrates an example sequence diagram for implementing the distributed data system to check the consistency of data records in accordance with one or more implementations.

FIG. 4A illustrates an example sequence diagram for implementing the distributed data system to move data records between backend storage partition devices in accordance with one or more implementations.

FIG. 4B illustrates an example sequence diagram for implementing the distributed data system to resolve data conflicts between backend storage partition devices in accordance with one or more implementations.

FIG. 5 illustrates an example sequence diagram for implementing the distributed data system to resolve data conflicts between a centralized cache device and backend storage partition in accordance with one or more implementations.

FIG. 6 illustrates an example series of acts for efficiently managing data records in a distributed directory system based on distributed backend storage partition devices in accordance with one or more implementations.

FIG. 7 illustrates another example series of acts for efficiently managing data records in a distributed directory system based on distributed backend storage partition devices in accordance with one or more implementations.

FIG. 8 illustrates certain components that may be included within a computer system.

### DETAILED DESCRIPTION

Implementations of the present disclosure provide benefits and solve the problems mentioned above through systems and methods that utilize a distributed data management system to provide improved data management, redundancy, and reliability in distributed directory systems. To illustrate, a distributed data management system provides features that involve relocating and distributing the management of data records from a centralized cache device to the backend storage partition devices. In this manner, the backend storage partition devices become responsible for automatically pushing data record metadata and changes to the centralized cache device, which passively redirects incoming requests to the proper backend storage partition devices. Additionally, the backend storage partition devices automatically resolve conflicts and restore lost data if the centralized cache device or a backend storage partition device suffers from faults or device failures.

To illustrate, in some implementations, the distributed data management system (or simply “distributed data system”) provides a first indication that a first backend storage partition manages a data record, where the indication is provided from the first backend storage partition device (or simply “first backend storage partition”) in a distributed data system and to a centralized cache device (or simply “centralized cache”) in the distributed data system. In addition, the distributed data system sends, from the first backend storage partition to the centralized cache, a consistency check regarding the management status of the data record.

In response to the consistency check, the distributed data system receives, at the first backend storage partition and from the centralized cache, metadata of the data record provided to the centralized cache from a second backend storage partition. Additionally, the distributed data system determines, at the first backend storage partition device, that the second backend storage partition manages the data record based on the metadata of the data record received from the centralized cache device.

In one or more implementations, the distributed data system receives, at a centralized cache in a distributed data system, a first indication from a first backend storage partition that the first backend storage partition manages a given data record (e.g., a data record with a given or particular data record identifier) as well as later receives a second indication from a second backend storage partition that the second backend storage partition now manages the given data record. In addition, the distributed data system may receive, at the centralized cache device, a consistency check from the first backend storage partition regarding the management status of the given data record.

In response to the consistency check, the distributed data system can provide metadata of the given data record from the centralized cache device to the first backend storage partition device, where the metadata was sent to the centralized cache device from the second backend storage partition. Additionally, in various implementations, the distributed data system determines, at the first backend storage partition device, that the second backend storage partition device manages the given data record based on comparing the metadata of the given data record received from the centralized cache to local metadata of the given data record stored at the first backend storage partition.

In many of the implementations described in this document, a data record is associated with a particular backend storage partition that is assigned or otherwise tasked with managing the data record. For example, a backend storage partition that manages a particular data record (e.g., a manager or a managing backend storage partition) may refer to a backend storage partition tasked with storing, controlling, or otherwise managing a data record. A managing backend storage partition (or simply “managing storage partition”) may be responsible for ensuring that the centralized cache has updated copies of metadata for its active data records. When conflicts arise between two backend storage partitions regarding responsibility for a given data record, each backend storage partition may compare local metadata associated with the given data record, which may sometimes be obtained via the centralized cache, to determine which backend storage partition is the designated managing storage partition.

As described above, modern-day distributed directory systems face several technical shortcomings that result in inefficient, inaccurate, and inflexible computer operations, particularly in the area of data management. For example, conventional approaches that involve centralized management of distributed directory systems often add large amounts of latency. In particular, existing computer systems perform numerous operations, such as data distribution, storage, tracking, and administration tasks through a centralized directory server. As a consequence of running so many data operations of the distributed directory system through a centralized directory server, processing bottlenecks and increased latency can become significant issues. These issues are magnified as the system becomes larger and as the storage resources become more and more decentralized. In addition, as the network of servers grows, and as additional data and partitioned directory servers are added, these conventional centralized systems fail to scale effectively to meet the increased demand. As a result, the latency and processing issues often worsen as the system becomes more complex and distributed.

To overcome these and other technical problems, the distributed data system provides several technical benefits in terms of computing efficiency, accuracy, and flexibility compared to existing computing systems. Indeed, the distributed data system provides several practical applications that deliver benefits and/or solve problems associated with improving data management, redundancy, and reliability in distributed directory systems. Some of these benefits are discussed in further detail below.

As a first example, the distributed data system provides improved efficiency over existing computer systems by relocating and distributing the management of data records. For example, by moving the processing and management of data records to each backend storage partition rather than at a central directory, the distributed data system can easily scale without introducing latency, without additional physical resources on the central directory, and without facilitating complex coordination between devices. To illustrate, instead of a centralized directory server managing or otherwise being responsible for all the data records, each backend storage partition manages or is exclusively responsible for a number of data records. When changes to data records occur, such as new data records being added or data records moving between backend storage partitions, the backend storage partitions are responsible for providing updates to the centralized cache.

As another example related to improving efficiency and flexibility, by relocating management to backend storage partitions and reversing the direction of data management, the distributed directory system is greatly simplified over existing computer systems. For example, in implementations described herein, the centralized cache becomes a more passive device than conventional systems by fulfilling incoming requests through reading and returning stored metadata. In many implementations, the backend storage partitions provide the same queries as external computing devices, which allows the centralized cache to be optimized for fulfilling all incoming requests regardless of if the request is internal or external.

As an example related to improving efficiency and accuracy, the distributed data system automatically updates data on the centralized cache to match data from the backend storage partitions. Unlike existing computer systems that require the metadata to match on both the centralized directory server and the partitioned directory servers, the distributed data system allows the centralized cache to include different data from the backend storage partition. This is because the backend storage partition, as owners of their data records, will regularly verify that the centralized cache has the same data records and the centralized cache is correctly pointing to them as the manager of a given data record, and if not, to simply and quickly rectify the discrepancy. This process is performed simply and automatically, without the need for manual verification or user intervention.

As a further example related to improving efficiency and accuracy, the distributed data system may automatically resolve conflicts between a backend storage partition and the centralized cache as well as between different backend storage partitions. For example, in some implementations, a backend storage partition gets the metadata stored on the centralized cache for a given record and compares it to local metadata of the same data record to determine if it is the manager of the given data record or if another backend storage partition manages the given data record. With this process, each backend storage partition will arrive at the same result as to the correct manager. Additionally, if a backend storage partition is not properly designated as the manager of a given data record at the centralized cache, the backend storage partition managing the data record will automatically remedy the error.

As an example related to improving flexibility, the distributed data system is able to capitalize on the same network architecture as existing computer systems. For example, an existing computer system can be improved by moving and distributing the management and maintenance of data records to the backend storage partitions. Additionally, the centralized directory server can be optimized into a centralized cache that acts passively (e.g., acts in response to incoming requests) rather than needing to actively manage the entire distributed directory system.

As an example related to improving efficiency, flexibility, and accuracy, the distributed data system dynamically resolves device failures. For example, if the centralized cache rolls back to a prior version (or fails completely with no backup), the backend storage partitions are able to automatically restore the centralized cache to the current and correct state. Indeed, because the backend storage partitions manage the data records, they will provide the most recent data records to the centralized cache via their regular verification checks (e.g., data consistency checks). Similarly, if a backend storage partition suffers a device fault and rolls back to a prior version, the backend storage partitions utilize the metadata on the centralized cache to resolve any data record conflicts between each other. In this manner, the distributed data system is able to self-heal, and this self-healing occurs automatically and dynamically without the need for manual user intervention.

As illustrated in the foregoing discussion, the present disclosure utilizes a variety of terms to describe the features and advantages of one or more implementations described herein. Some examples of these terms will be discussed below.

For example, as used herein, “distributed directory system” refers to a network environment where data is stored on multiple partitioned devices. In many instances, a distributed directory system includes a central device that stores the location of each piece of data (e.g., data records). For example, in the distributed directory system described herein, a centralized cache device may include a mapping of which data records are stored at which backend storage partition devices (e.g., which backend storage partition devices manage which data records). In one or more implementations, the distributed directory system is inclusive of the backend storage devices and a centralized cache.

For example, as used herein, the term “centralized cache device” (or simply “centralized cache”) refers to a server that fields incoming requests associated with data records. As used herein, a centralized cache includes a table, mapping, or other data structure that indicates which backend storage partition device manages which data record (as previously received from the respective backend storage partition devices that have claimed management). In various implementations, the centralized cache stores metadata of data records. For example, the metadata for a given data record stored on the centralized cache is at least a subset of the metadata of the given data record found on the backend storage partition device that manages (e.g., stores and maintains) the given data record. Often the managing backend storage partition device will have additional metadata as well as the actual content of the data record (e.g., non-metadata information).

As another example, as used herein, the term “backend storage partition device” (or simply “backend storage partition”) refers to a server device, storage device, database, or another type of computing device that stores data records within a distributed directory system. In various implementations, a backend storage partition includes the distributed data system, or a portion of the system, to manage its data records, provide metadata for data records to the centralized cache, resolve conflicts, and/or correct outdated depth data. As described below, backend storage partitions are not regularly connected to each other, but indirectly communicate via the centralized cache. In some instances, however, a backend storage partition moves a data record to another backend storage partition, which may temporarily involve more direct communication.

As another example, as used herein, the term “data record” refers to one or more pieces of data that are associated with a user identifier or a device identifier. For example, a data record is a data shard (or simply “shard”). A data record or shard is individually addressable, moveable, manageable, and creatable. In addition, a data record or shard is wholly stored on a backend storage partition and is largely active on one backend storage partition at a time. A data record can include, or be associated with, a unique identifier, attributes (e.g., the content of a data record), location information (e.g., the backend storage partition at which it is maintained), metadata (e.g., information about the data record), timestamps (e.g., modification times when metadata and/or attributes change), and e-tags (e.g., change markers that indicate when changes occur), among other information. An example of a backend storage partition is a server that stores mailbox information for users of an e-mail service.

As another example, as used herein, the term “metadata” refers to data about a data record rather than the content of a data record itself. As noted above, a centralized cache stores some or all of the metadata for a given data record, which can include the backend storage partition that manages the given data record. Metadata can also include timestamp information that indicates modification times of the metadata and/or attributes of the data record. Backend storage partitions can generate or create metadata and provide it to the centralized cache. As noted below, metadata may be used to determine which backend storage partition manages a given data record.

In one or more implementations described herein, a data record may be associated with a particular backend storage partition that is assigned or otherwise tasked with managing the data record. As discussed in further detail below, a backend storage partition that is a manager of a particular data record (e.g., a “managing backend storage partition”) may refer to a backend storage partition tasked with storing, controlling, or otherwise maintaining a data record. A managing backend storage partition (or simply, a “managing storage partition”) may be responsible for ensuring that the centralized cache has updated copies of metadata for its active data records. When conflict arises between two backend storage partitions regarding responsibility for a given data record, each backend storage partition may compare local metadata associated with the given data record (sometimes obtains via the centralized cache) to determine which backend storage partition is the designated managing storage partition.

As another example, as used herein, the term “consistency check” refers to a backend storage partition, which manages a given active data record, regularly or periodically verifying its record of management for the given data record with the centralized cache. For example, a first backend storage partition provides a check to the centralized cache for a given data record regarding who the centralized cache has recorded as the managing backend storage partition (or simply “manager”) of the given data record. Because data records move between backend storage partitions and because devices can roll back to previous states, management conflicts can be common. Accordingly, if the centralized cache indicates a second backend storage partition as the manager of the given data record, the first data record can automatically resolve the management conflict with itself by utilizing the metadata of the given data record. Likewise, the second and other backend storage partitions will reach the same management resolution for the given data record.

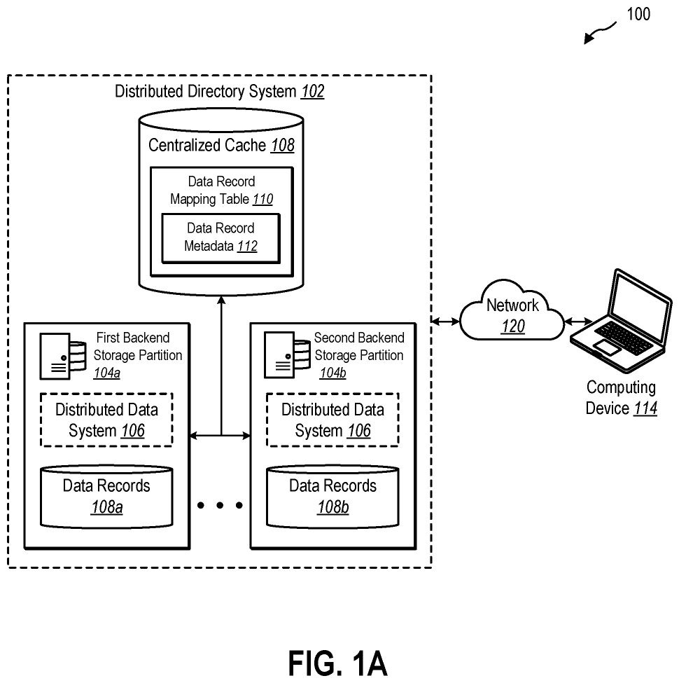

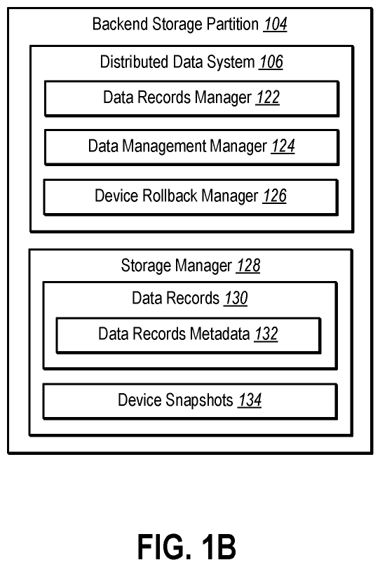

Additional details will now be provided regarding the components and elements of the distributed data system. To illustrate, FIGS. 1A-1B illustrate a schematic diagram of an environment 100 (e.g., a digital medium system environment) for implementing a distributed data system 106 (e.g., a distributed data management system). In particular, FIG. 1A includes the environment 100 and FIG. 1B provides additional detail regarding components and elements of the distributed data system 106.

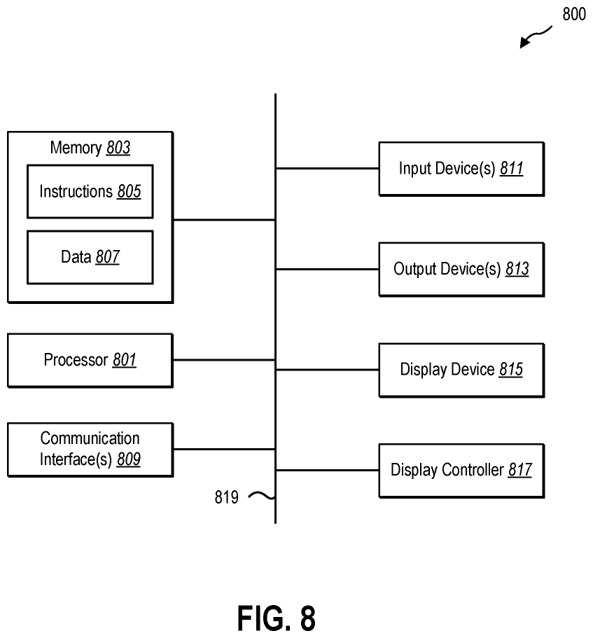

As illustrated in FIG. 1A, the environment 100 includes a distributed directory system 102 having a centralized cache 108 (e.g., a centralized cache device) and backend storage partitions (e.g., backend storage partition devices). The environment 100 also includes a computing device 114 in communication with the distributed directory system 102 via a network 120. Additional details regarding these and other computing devices are provided below in connection with FIG. 8. In addition, FIG. 8 also provides additional details regarding networks, such as the network 120 shown.

As just mentioned, the environment 100 includes the distributed directory system 102 having the centralized cache 108 and the backend storage partitions. In particular, the distributed directory system 102 shows a first backend storage partition 104a and a second backend storage partition 104b, however, the distributed directory system 102 will commonly have additional backend storage partitions. In various implementations, the centralized cache 108 and the backend storage partitions are server devices. Additionally, in some implementations, the distributed directory system 102 spans a large geographic span and utilizes one or more networks, similar to the network 120 to communicate with each other.

As shown in FIG. 1A, the first backend storage partition 104a includes the distributed data system 106 and data records 108a. Similarly, the second backend storage partition 104b includes the distributed data system 106 and data records 108b. In one or more implementations, multiple instances of the distributed data system 106 (or portions of it) are located at each backend storage partition, which is represented in FIG. 1A by the distributed data system 106, illustrated in dashed lines. In various implementations, the distributed data system 106, or a portion of it, is located on the centralized cache 108.

As further shown in FIG. 1A, the centralized cache 108 includes a data record mapping table 110 that includes data record metadata 112. In various instances, the data record metadata 112 includes metadata for data records stored at, and provided by, the backend storage partitions, while the data record mapping table 110 indicates which data records are stored at which backend storage partition.

Also shown in FIG. 1A, the environment 100 includes the computing device 114. Among various implementations, the computing device 114 is a client device associated with a user (e.g., a user client device). In additional implementations, the user is represented by a user identifier that corresponds to a data record. In some implementations, the computing device 114 is a server device or other type of computing device and has a device identifier associated with a data record. The computing device 114 includes an interface that allows it to communicate and send requests to the distributed directory system 102. For example, the interface is a web browser application, a mobile application, or another type of application that allows the computing device 114 to send requests to the distributed directory system 102 that are associated with data records.

To further illustrate, suppose a data query is sent from the computing device 114 to the distributed directory system 102. In response, the centralized cache 108 initially receives the data query and identifies a data record identifier in the data query. Utilizing the data record identifier, the centralized cache 108 looks up the metadata of the data record as well as which backend storage partition manages the data record. In this example, suppose the first backend storage partition 104a manages the given data record. Accordingly, the centralized cache 108 redirects the data query to the first backend storage partition 104a to directly or indirectly fulfill the data request and provide a query result back to the computing device 114.

In the above example, the first backend storage partition 104a manages, maintains, and manages the given data record. Accordingly, the first backend storage partition 104a is responsible for indicating such to the centralized cache 108. For example, the first backend storage partition 104a generates or creates metadata of the given data record and provides the metadata to the centralized cache 108 to be stored. Additionally, the first backend storage partition 104a indicates to the centralized cache 108 that it manages the given data record. Further, the first backend storage partition 104a sends periodic consistency checks to the centralized cache 108 to ensure its management status is recorded correctly as well as provides any updates for the given data record to the centralized cache 108 (e.g., by sending updated metadata).

Although FIG. 1A illustrates a particular number, type, and arrangement of components within the environment 100, various additional environment configurations and arrangements are possible. For example, the components of the distributed directory system 102 are connected via one or more networks, similar to the network 120, to communicate with each other. As another example, the environment 100 may include any number of computing devices, such as additional client devices that send data queries to the distributed directory system 102. Further, the distributed directory system 102 includes additional backend storage partitions that store data records.

As mentioned above, FIG. 1B provides additional details regarding the capabilities and components of the distributed data system 106. To illustrate, FIG. 1B shows a backend storage partition 104 having the distributed data system 106. For example, the backend storage partition 104 represents one of the backend storage partitions within the distributed directory system 102 introduced above. While FIG. 1B provides additional details of the distributed data system 106, further detail and description regarding implementations of the distributed data system 106 are provided in subsequent figures. Additionally, as noted above, in various implementations, some of, or instances of, the distributed data system 106 is located on the centralized cache 108.

As illustrated in FIG. 1B, the distributed data system 106 includes various components and elements. For example, the distributed data system 106 includes a data records manager 122, a data management manager 124, a device rollback manager 126, and a storage manager 128. As also shown, the storage manager 128 includes data records 130, which have data record metadata 132, and device snapshots 134. The distributed data system 106 can include additional or different components and/or elements such as a backend storage partition lookup manager and a data records mapping manager (e.g., when operating on the centralized cache).

As just mentioned, the distributed data system 106 includes the data records manager 122. In various implementations, the data records manager 122 receives, identifies, processes, forwards, responds to, and/or otherwise manages data records 130. For example, the data records manager 122 maintains and manages data records 130 on the backend storage partition 104. In some implementations, the data records manager 122 generates data record metadata 132 for the data records 130 and provides the metadata to the centralized cache 108. Additionally, the data records manager 122 provides updates (e.g., updated metadata) to the centralized cache when a new data record is added or an existing data record changes. Among one or more implementations, the data records manager 122 marks a data record as active or inactive depending on its current activity status.

As mentioned above, the distributed data system 106 includes the data management manager 124. In various implementations, the data management manager 124 verifies proper management of data records stored on the backend storage partition 104. For example, the data management manager 124 periodically or regularly sends out consistency checks to the centralized cache 108 for active data records. In some implementations, the centralized cache 108 responds by indicating that another backend storage partition manages a given data record. In these implementations, the data management manager 124 utilizes multiple instances of metadata of the given data record to efficiently resolve the management issue, as further described below. In other implementations, the centralized cache 108 provides back its stored metadata of the given data record, and the data management manager 124 determines if the management is correct, which is also described below in greater detail.

As mentioned above, the distributed data system 106 includes the device rollback manager 126. In one or more implementations, the device rollback manager 126 manages rollbacks of the backend storage partition 104 when a device fault or error occurs. For example, the device rollback manager 126 detects when the backend storage partition 104 has a device fault and/or when writes to the data records 130 are not occurring. The device rollback manager 126 may also determine to roll back for other reasons. Accordingly, the device rollback manager 126 rolls back the backend storage partition 104 to a previous version, often captured by a device snapshots 134, which is a full or partial previous copy of the backend storage partition 104. Once the backend storage partition 104 rolls back to a previous version, the distributed data system 106 can utilize the data management manager 124 to update and self-heal the data records 130 that may have incorrect activity statuses as well as fix other issues.

Additionally, the distributed data system 106 includes the storage manager 128. In various implementations, the storage manager 128 includes data used by any of the components of the distributed data system 106 in performing features and functionality described herein. For example, the storage manager 128 may include the data records 130 having the data record metadata 132, the device snapshots 134, and/or additional data.

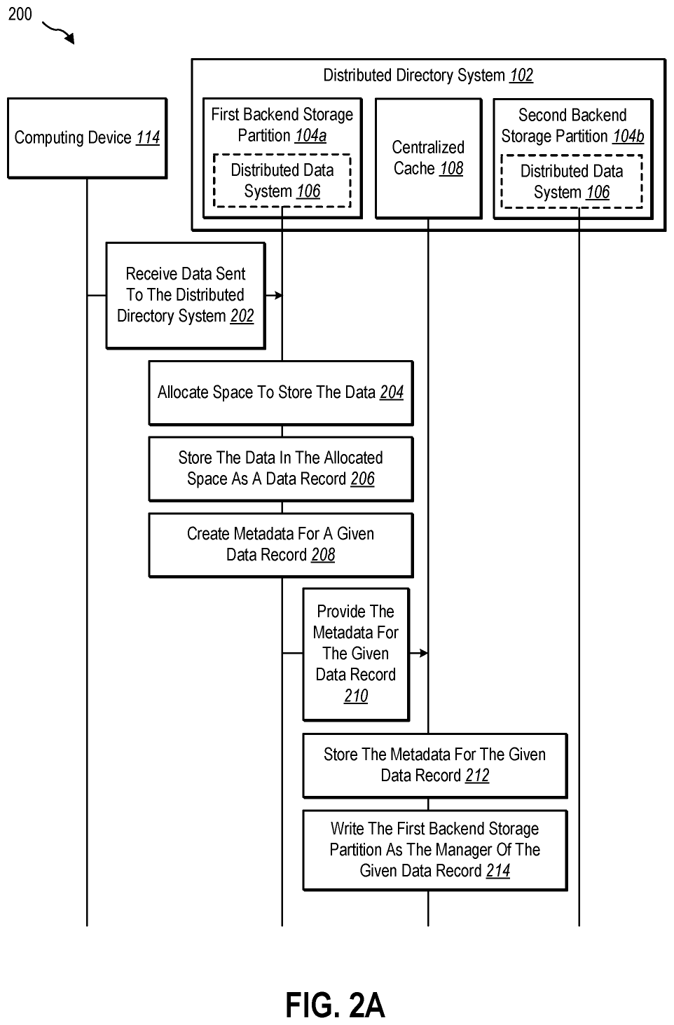

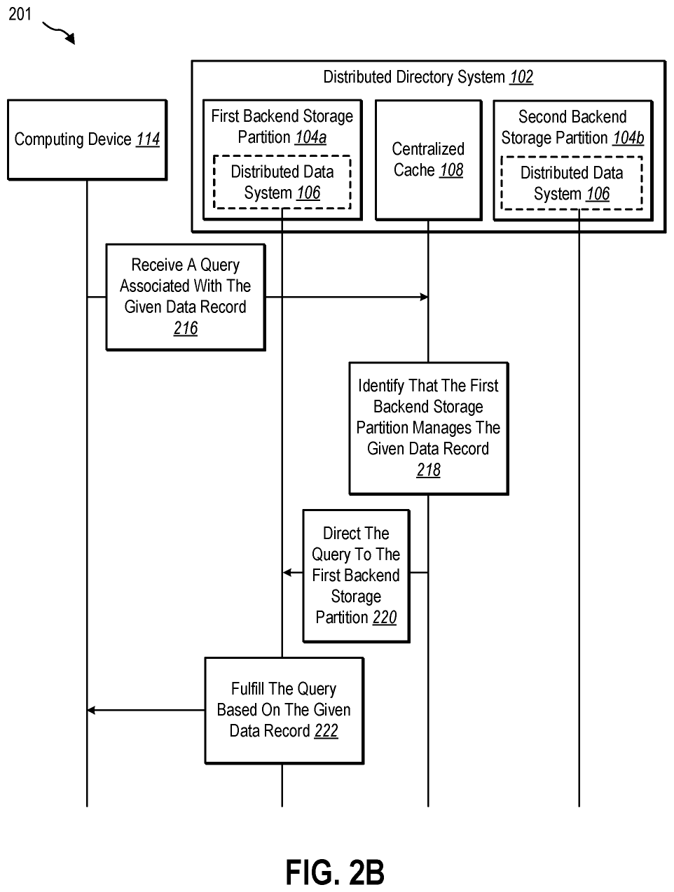

The next set of figures (e.g., FIGS. 2A-2B, FIG. 3, FIGS. 4A-4B, and FIG. 5) provide examples of how the distributed data system 106 efficiently manages data records from a backend storage partition-based perspective. In particular, these figures walk through different use-cases related to generating or creating new data records, moving data records between backend storage partitions, resolving data record conflicts based on the centralized cache rolling back to a previous version, and resolving data record conflicts based on a backend storage partition rolling back to a previous version.

As shown, these figures each include components previously introduced. For example, these figures include the distributed directory system 102 having the first backend storage partition 104a, the second backend storage partition 104b, and the centralized cache 108. The distributed data system 106 is also shown as part of each backend storage partition. In addition, each of these figures includes a series of acts performed by or in connection with the distributed data system 106. Additionally, these figures reference a given data record, which can be the same or a different data record in each figure.

To illustrate, FIG. 2A illustrates an example sequence diagram for implementing the distributed data system to add data records to the distributed directory system in accordance with one or more implementations. As shown, FIG. 2A includes a first series of acts 200 for adding data records.

As shown in FIG. 2A, the first series of acts 200 includes an act 202 of the first backend storage partition 104a receiving data sent to the distributed data system from the computing device 114. In various implementations, the data is associated with a user identifier or a device identifier. For example, the computing device 114 is a user client device and registers an account with the distributed directory system 102. As another example, the computing device 114 is an email server and is sending a newly received email to the distributed directory system 102, which includes email functionality. The computing device 114 may send new data to the distributed directory system 102 for various reasons, which the distributed directory system 102 stores as a new data record.

In response, the first backend storage partition 104a allocates space to store the data, as shown in the act 204 of the first series of acts 200. In particular, the distributed data system 106 on the first backend storage partition 104a allocates storage space within a database or storage portion of the first backend storage partition 104a. Additionally, as shown in the act 206 of the first series of acts 200, the first backend storage partition 104a stores (e.g., writes) the data as a data record in the allocated space as a data record (e.g., a new data record). In various implementations, the distributed data system 106 associates the data record (called a given data record for ease of explanation) with a user identifier or a device identifier.

As shown in FIG. 2A, the first series of acts 200 includes an act 208 of the distributed data system 106 creating metadata of the given data record. For example, in various implementations, in connection with storing the given data record, the distributed data system 106 also generates metadata of the given data record. In some implementations, the data sent over from the computing device 114 includes pre-generated metadata (or portions of metadata). In some instances, the distributed data system 106 gathers, curates, and/or otherwise organizes the metadata. In many implementations, the distributed data system 106 updates the metadata with current timestamp information, such as when the given data record was written to the first backend storage partition 104a. The distributed data system 106 may also generate and/or store other types of metadata along with the given data record.

As further shown in FIG. 2A, the first series of acts 200 includes the act 210 of providing the metadata of the given data record to the centralized cache 108. For example, the first backend storage partition 104a sends a copy of the metadata of the given data record to the centralized cache 108 to be stored. In various implementations, the first backend storage partition 104a sends a subset of the metadata to the centralized cache 108.

In some implementations, the first backend storage partition 104a sends an indication, separately or as part of the metadata, indicating management of the given data record. For example, the first backend storage partition 104a first sends an indication of management for the given data record before or in connection with sending the metadata of the given data record. In some implementations, sending metadata for a data record implicitly indicates management by the sending backend storage partition. In other implementations, the metadata includes a management attribute that is read by the centralized cache 108, which indicates that the backend storage partition that manages the data record.

As shown in FIG. 2A, the first series of acts 200 includes an act 212 of the centralized cache 108 storing the metadata of the given data record. For example, the centralized cache 108 receives and passively stores the metadata. Indeed, in these implementations, the first backend storage partition 104a pushes the metadata of the given data record to the centralized cache 108 to passively store without requiring the centralized cache 108 to manage, monitor, or manage the given data record.

As also shown in FIG. 2A, the first series of acts 200 includes an act 214 of the centralized cache 108 writing the first backend storage partition 104a as the manager of the given data record. For example, the centralized cache 108 writes to a mapping table (e.g., a data record metadata mapping table) indicating that the first backend storage partition 104a currently manages the given data record. In this manner, incoming data queries and requests for the given data record can be quickly redirected to the first backend storage partition 104a.

Moving to FIG. 2B, this figure illustrates an example sequence diagram for implementing the distributed data system 106 to retrieve data records in accordance with one or more implementations. As shown, FIG. 2B includes a second series of acts 201 for retrieving a data record.

As shown, the second series of acts 201 includes an act 216 of the distributed data system 106 receiving a query (e.g., a data query) associated with the given data record. For example, the same or different computing device provides a request to the distributed directory system 102, which is received by the centralized cache 108, where the request includes a data query requesting information associated with the given data record.

In response, as shown in the act 218 of the second series of acts 201, the distributed data system 106 identifies that the first backend storage partition 104a manages the given data record. For example, the centralized cache 108 searches a data record metadata mapping table utilizing a data record identifier from the data query to identify 1) an entry for the first backend storage partition 104a and 2) that the first backend storage partition 104a is the current manager of the given data record. Additionally, the centralized cache 108 retrieves the stored metadata associated with the metadata.

As shown, the second series of acts 201 includes an act 220 of the centralized cache 108 directing the query to the first backend storage partition 104a. In various implementations, directing the query to the first backend storage partition 104a includes forwarding or passing off the data query (or a portion of it) to the first backend storage partition 104a to be processed (e.g., based on the content of the data record) and returned. In some implementations, directing the query to the first backend storage partition 104a includes sending another request, often more specific and in the background, from the centralized cache 108 to the first backend storage partition 104a and having the result returned to the centralized cache 108. In a few implementations, the centralized cache 108 is able to fulfill the request from its stored metadata without needing to direct the data query onward.

Additionally, as shown, the second series of acts 201 includes an act 222 of the distributed data system 106 fulfilling the query based on the given data record. For example, upon the first backend storage partition 104a receiving the data query or an associated request, the distributed data system 106 looks up the given data record and utilizes the contents of the given data record to fulfill the request. In some implementations, the first backend storage partition 104a sends the result to the computing device 114 directly. In alternative implementations, the first backend storage partition 104a sends the result via the centralized cache 108.

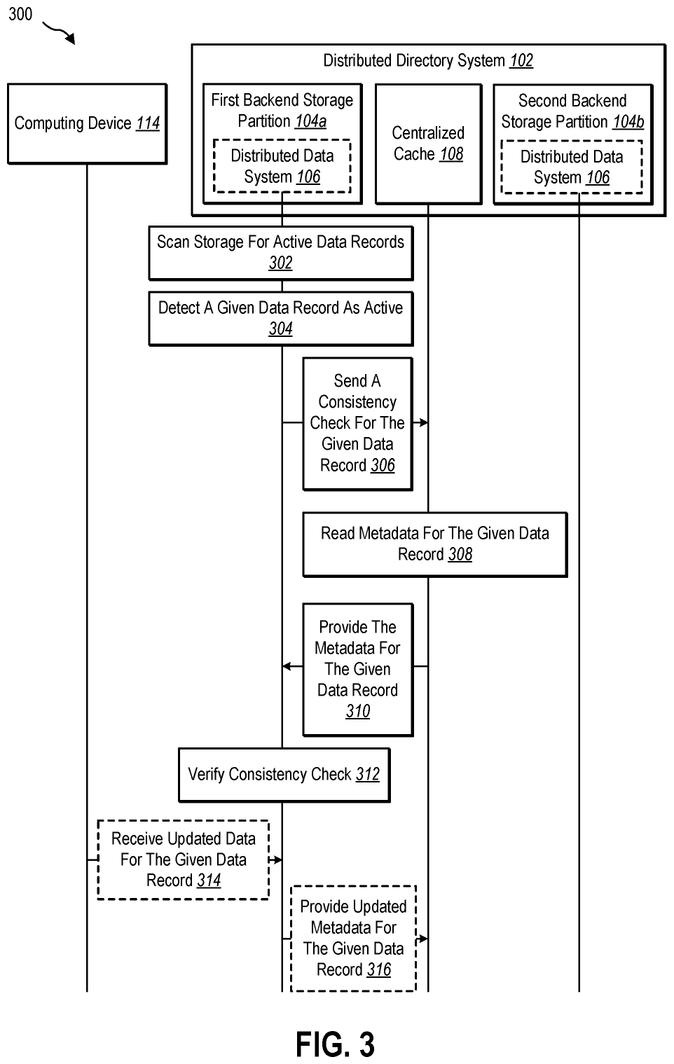

Moving to the next figure, FIG. 3 illustrates an example sequence diagram for implementing the distributed data system to check the consistency of data records in accordance with one or more implementations. As shown, FIG. 3 includes a series of acts 300 for verifying management of a given data record via a consistency check.

As shown in FIG. 3, the series of acts 300 includes an act 302 of the distributed data system 106 scanning storage for active data records. For example, the distributed data system 106 scans data records to identify active data records stored on the first backend storage partition 104a. For instance, active data records have an activity flag set to true. In some implementations, data records that have been modified within a predetermined time (e.g., a week, month, year, etc.) are considered active. Additionally, the series of acts 300 includes an act 304 of the distributed data system 106 detecting a given data record as active.

As shown, the series of acts 300 includes an act 306 of the first backend storage partition 104a sending a consistency check for the given data record to the centralized cache 108. For instance, the distributed data system 106 on the first backend storage partition 104a sends a consistency check with a data record identifier of the given data record to the centralized cache 108 to inquire regarding the management and metadata status of the given data record as it is stored on the centralized cache 108. For example, the first backend storage partition 104a sends a read request to the centralized cache 108 requesting what metadata and/or data the centralized cache 108 has stored for the given data record.

In various implementations, the distributed data system 106 sends a consistent check at regular intervals. For example, in one or more implementations, the distributed data system 106 continuously rotates through all active data records and performs consistent checks. In some implementations, the distributed data system 106 performs checks periodically, such as every x minutes. In various implementations, the distributed data system 106 performs a consistent check for an active data record that has not been verified in the last x minutes or hours. In certain implementations, the distributed data system 106 performs a consistent check after a predetermined number of data records have been modified and/or accessed.

Additionally, the distributed data system 106 may perform a consistency check for each active data record individually or as part of a bulk request. In many implementations, sending a consistent check to the centralized cache 108 utilizes the same protocols as a computing device sending a data request. Accordingly, the centralized cache 108 can be highly optimized to receive both of these types of requests, read the appropriate metadata for data records, and quickly provide results. Indeed, in this manner the distributed data system 106 greatly simplifies the operations of the centralized cache 108 over existing computer systems.

In response to receiving the consistency check, as shown in the act 308 of the series of acts 300, the centralized cache 108 reads metadata of the given data record. In some implementations, the centralized cache 108 also, or in an alternative, provides management status of the given data record (the backend storage partition to whom the centralized cache 108 forwards incoming data queries for the given data record), which may be in a separate mapping table or location from the metadata of the given data record. In one or more implementations, the management status is paired with the metadata of the given data record. For example, the management status is stored as part of the metadata of the data record.

As shown, the series of acts 300 includes an act 310 of the centralized cache 108 providing the management and/or metadata for the given data record to the first backend storage partition 104a. In various implementations, the centralized cache 108 sends back stored metadata of the given data record and the first backend storage partition 104a directly or indirectly determines from this metadata that it manages the given data record, which is also described further below. In one or more implementations, the centralized cache 108 sends an indication to the first backend storage partition 104a that it has the first backend storage partition 104a as the manager of the given data record (e.g., the centralized cache 108 is forwarding incoming data queries for the given data record to the first backend storage partition 104a). As provided below, in some implementations, the centralized cache 108 indicates that it forwards incoming data queries for the given data record to another backend storage partition.

Further, as shown, the series of acts 300 includes an act 312 of the distributed data system 106 verifying the consistent check. In various implementations, the first backend storage partition 104a compares the metadata received from the centralized cache 108 to its locally stored metadata for the given data record to determine that the first backend storage partition 104a manages the given data record, which is further described below. Upon confirming management, the first backend storage partition 104a updates a consistent check attribute for the given data record to indicate when the last consistent check was verified. In some implementations, verifying the consistency check means moving on to other active data records for their consistency checks. Alternatively, if the first backend storage partition 104a determines that it is not the manager of the given data record, the distributed data system 106 may begin the process of automatically resolving management, which is described further below.

As shown in FIG. 3, the series of acts 300 includes an optional act 314 of receiving updated data for the given data record from the computing device 114. For instance, the computing device 114 provides additional and/or different data associated with the data record, such as deleting an email data record. In response, the distributed data system 106 on the first backend storage partition 104a can store the updated data in connection with the given data record as well as generate updated metadata of the given data record. Notably, the optional act 314 and the optional act 316 (described next) can occur at any time after the given data record has been created on the first backend storage partition 104a.

As mentioned, the series of acts 300 includes an optional act 316 of the first backend storage partition 104a providing the updated metadata of the given data record to the centralized cache 108. For instance, upon generating the updated metadata of the given data record, the distributed data system 106 on the first backend storage partition 104a provides the updated metadata of the given data record for the centralized cache 108 to update and store on its end. Accordingly, because the first backend storage partition 104a manages and maintains the given data record, anytime meaningful changes to the given data record occur, the first backend storage partition 104a is responsible for pushing these changes to the centralized cache 108, so the centralized cache 108 will usually be up-to-date.

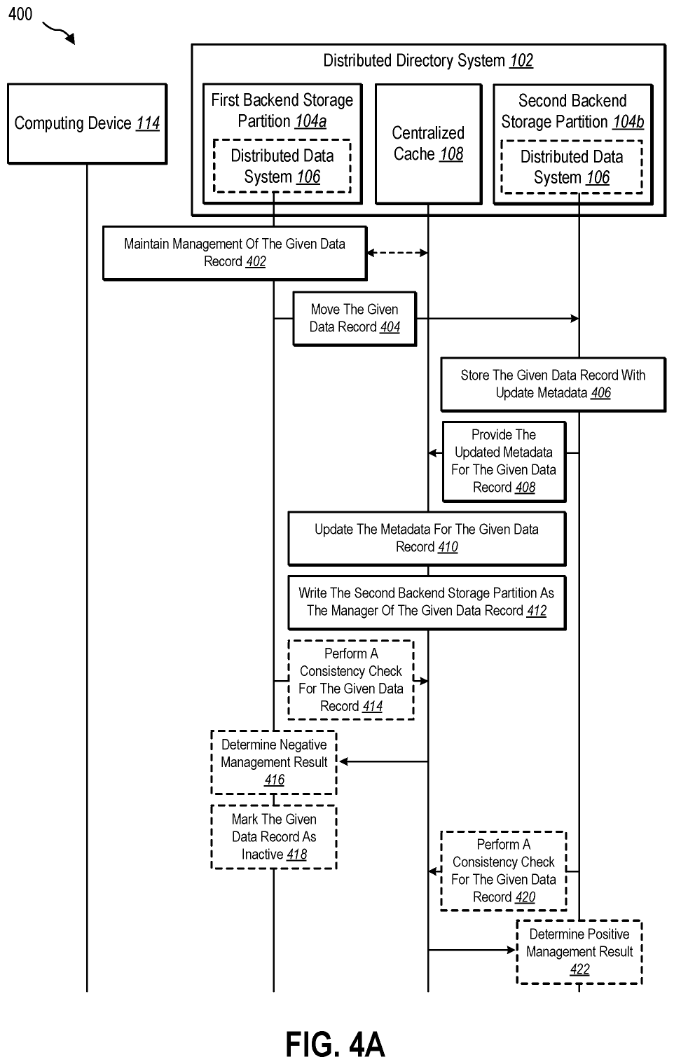

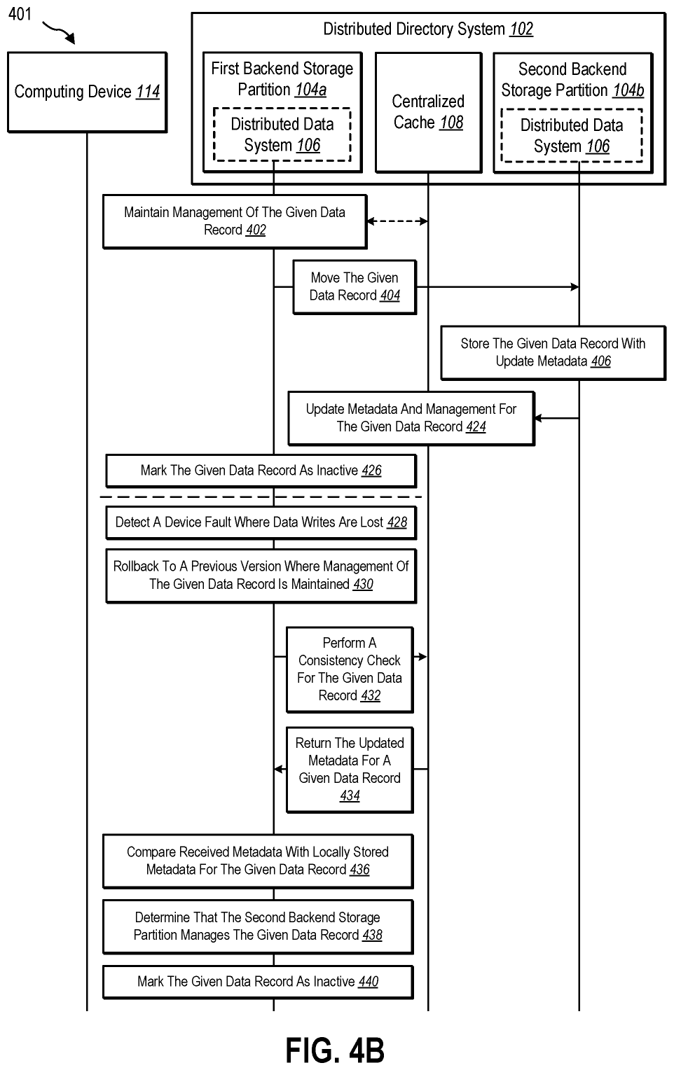

Moving to the next set of figures, FIG. 4A illustrates an example sequence diagram for implementing the distributed data system to move data records between backend storage partitions in accordance with one or more implementations. As illustrated, FIG. 4A includes a first series of acts 400 for moving data records between backend storage partitions and automatically updating the centralized cache as a result of the move.

As shown in FIG. 4A, the first series of acts 400 includes an act 402 of the first backend storage partition 104a maintaining management of the data record. For example, the dashed arrow represents previously described actions, such as storing the data record on the first backend storage partition 104a and interacting with the centralized cache 108 to ensure that it points to the first backend storage partition 104a as the manager of the data record.

As further shown in FIG. 4A, the first series of acts 400 includes an act 404 of moving the data record from the first backend storage partition 104a to the second backend storage partition 104b. Relocation of a data record (e.g., a data shard) may occur for a number of reasons, such as storage partition rebalancing, backend storage evaluation, or regional location requirements. In various implementations, the first backend storage partition 104a pushes the data record to the second backend storage partition 104b. In some implementations, the first backend storage partition 104a and the second backend storage partition 104b send various communications between each other to move or relocate the data record. In a few implementations, the distributed data system 106 on the first backend storage partition 104a also sends an indicator to the centralized cache 108 that management of the data record is moved to the second backend storage partition 104b.

As shown in FIG. 4A, the first series of acts 400 includes an act 406 of the second backend storage partition 104b storing the data record with updated metadata. For example, the distributed data system 106 on the second backend storage partition 104b first stores the data record in a data records database or data records store. Additionally, in various implementations, the distributed data system 106 generates updated metadata of the data record, such as for indicating the relocation time and/or other changes that have occurred with the data record. The distributed data system 106 may also store the updated metadata in connection with the data record on the second backend storage partition 104b.

As shown in FIG. 4A, the first series of acts 400 includes an act 408 of the second backend storage partition 104b providing the updated metadata of the data record to the centralized cache 108. Indeed, the distributed data system 106 on the second backend storage partition 104b, which now manages the data record, becomes responsible for managing the data record and ensuring that information about the data record is updated at the centralized cache 108. Accordingly, the distributed data system 106 on the second backend storage partition 104b sends the updated metadata to the centralized cache 108, which updates the metadata of the data record on its end, as shown as the act 410 of the first series of acts 400.

The first series of acts 400 includes an act 412 of the centralized cache 108 writing the second backend storage partition 104b as the manager of the data record. For example, in response to receiving the updated metadata and/or an indication of management from the second backend storage partition 104b, the centralized cache 108 updates the data record mapping table to indicate that management for the data record has been changed from the first backend storage partition 104a to the second backend storage partition 104b. Once updated at the centralized cache 108, any data queries for the data record will be received by the centralized cache 108 and redirected to the second backend storage partition 104b.

As shown in FIG. 4A, the first series of acts 400 includes a number of optional acts. For example, the series of acts 400 includes an optional act 414 of the first backend storage partition 104a performing a consistency check for the data record, which occurs after the relocation of the data record. In response, the first backend storage partition 104a determines a negative management result, as shown in the act 416 of the first series of acts 400. As described in detail above, the first backend storage partition 104a determines from the updated metadata a negative management result for the given data record based on corresponding metadata provided by the centralized cache 108 in response to the consistent check. Additionally, because the data record has been relocated to the second backend storage partition 104b, the centralized cache 108 should not send data queries to the first backend storage partition 104a.

The first series of acts 400 may also include an optional act 418 of the first backend storage partition 104a marking the data record as inactive. For example, the distributed data system 106 on the first backend storage partition 104a sets an activity flag or attribute for the data record as false or negative. In various implementations, the first backend storage partition 104a deletes or archives the data record any time after the relocation. In some instances, it waits for a negative management result before archiving the data record.

Similarly, as shown in FIG. 4A, the first series of acts 400 includes an optional act 420 of the second backend storage partition 104b performing a consistency check for the data record. In response, the second backend storage partition 104b determines a positive management result, as shown in the act 422 of the first series of acts 400. In some implementations, as part of determining the positive management result, the second backend storage partition 104b provide a management indication to the centralized cache 108, as described further below.

In various implementations, a computing device 114 sends a data query to the distributed directory system 102 that is associated with the data record. For instance, the centralized cache 108 receives the data query after the data record has been relocated to the second backend storage partition 104b but before the management status has been updated at the centralized cache 108. In these instances, the centralized cache 108 believes the first backend storage partition 104a to be the manager and redirects the data query to it. In some cases, the first backend storage partition 104a fulfills the data query by providing or surfacing the requested information. In other cases, even though the first backend storage partition 104a still maintains a copy of the data record, if it is marked as inactive, the first backend storage partition 104a denies the request as it no longer manages the given data record. In some implementations, the first backend storage partition 104a directly (or via the centralized cache 108) further redirects the request to the second backend storage partition 104b.

Turning now to FIG. 4B, this figure illustrates an example sequence diagram for implementing the distributed data system to resolve data conflicts between backend storage partitions in accordance with one or more implementations. As shown, FIG. 4B includes a second series of acts 401 for automatically resolving management conflicts of data records between backend storage partitions, which then automatically report the resolved management status to the centralized cache 108.

As shown in FIG. 4B, the second series of acts 401 repeats the acts 402-406 described above in the first series of acts 400. As a reminder, the acts 402-406 describe the data record being first maintained by the first backend storage partition 104a, then moved to the second backend storage partition 104b. Additionally, the second series of acts 401 includes an act 424 of the centralized cache 108 updating metadata and management for the data record, which is a combination of the acts 410-412 described above in the first series of acts 400.

As also shown, the second series of acts 401 includes an act 426 of the first backend storage partition 104a marking the data record as inactive. As noted above, the first backend storage partition 104a can mark the data record as inactive at any time after relocating the data record or, in some cases, may wait for a negative management result from the centralized cache 108 in response to a consistency check.

As shown in FIG. 4B, the second series of acts 401 includes an act 428 of the first backend storage partition 104a detecting a device fault where data writes are lost. For example, sometime after marking the data record as inactive (where the dashed line indicates a variable amount of time), the distributed data system 106 or another part of the first backend storage partition 104a detects a device fault that obstructs previous or current writing operations, such that data records are not being properly stored. In some cases, the device fault prevents the retrieval of stored data records. Device faults may occur for a number of reasons that interfere with the operation of the first backend storage partition 104a.

In response to the device fault, the first backend storage partition 104a rolls back to a previous version, and in this previous version, the first backend storage partition 104a still maintains management of the data record. For example, the first backend storage partition 104a rolls back to a device snapshot that was taken before the relocation of the data record. In these situations, both the first backend storage partition 104a and the second backend storage partition 104b asset management over the data record.

As shown, the second series of acts 401 includes an act 432 of the first backend storage partition 104a performing a consistency check for the data record with the centralized cache 108. In response, the centralized cache 108 returns the updated metadata of the given data record, as shown in the act 434 of the series of acts.

In various implementations, the first backend storage partition 104a requests management information for the data record from the centralized cache 108 (e.g., who the centralized cache 108 has marked as the manager of the data record) and, in response, the centralized cache 108 indicates either that the first backend storage partition 104a is not indicated as the manager or that the second backend storage partition 104b is indicated as the manager. In some implementations, the first backend storage partition 104a requests whatever metadata the centralized cache 108 has stored for the data record and the first backend storage partition 104a utilizes this information to determine the manager, as described below. In some implementations, the centralized cache 108 returns its metadata and a management status indication for the data record to the first backend storage partition 104a.

As shown in FIG. 4B, the second series of acts 401 includes an act 436 of the distributed data system 106 on the first backend storage partition 104a comparing received metadata with locally stored metadata of the data record. For example, the first backend storage partition 104a receives the metadata that was stored at the centralized cache 108 for the data record and compares it to the corresponding metadata locally stored on the first backend storage partition 104a. If the metadata matches (or is within a threshold similarity), then the first backend storage partition 104a knows that it is the manager of the data record as it was the last backend storage partition to provide metadata to the centralized cache 108.

In the example shown in FIG. 4B, however, the metadata provided by the centralized cache 108 to the first backend storage partition 104a came from the second backend storage partition 104b (see the act 424). Accordingly, in this case, the first backend storage partition 104a determines that its locally stored metadata is different from the metadata provided from the centralized cache 108. Upon detecting a difference, the first backend storage partition 104a further compares the two different instances of metadata of the data record from the two different backend storage partitions to determine which backend storage partition is the correct manager.

To illustrate, in one or more implementations, the distributed data system 106 on the first backend storage partition 104a compares timestamps between the metadata (or one or more particular attributes of the metadata) to determine which backend storage partition most recently stored, modified, wrote, shared, changed, and/or updated the data record (and thus, the metadata of the data record). For example, if the metadata of the second backend storage partition 104b (e.g., the metadata provided by the centralized cache 108) has a newer or more recent timestamp for an attribute of the data record corresponding to the last modification than the same attribute from the metadata of the data record stored on the first backend storage partition 104a, then the distributed data system 106 determines that the second backend storage partition 104b manages the data record. This example is shown as the act 438 of the second series of acts 401. More generally, in this example, the first backend storage partition 104a determines that another backend storage partition manages the data record, as the first backend storage partition 104a does not need to know which specific backend storage partition manages the data record just as long as it knows it is not the manager.

As shown, the second series of acts 401 includes an act 440 of the first backend storage partition 104a marking the data record as inactive. In some implementations, the first backend storage partition 104a deletes the data record, archives it, and/or deallocates its storage space in connection with marking the data record as inactive.

In many implementations, based on comparing the metadata instances for the same data record, the first backend storage partition 104a can automatically confirm whether it is the manager of the data record after a device failure or rollback. Additionally, the first backend storage partition 104a does not need the centralized cache 108 to make the management determination. Furthermore, every backend storage partition that performs the metadata comparison between the metadata stored at the centralized cache 108 and its own locally stored metadata will correctly determine if it is the manager or another backend storage partition is the manager of the data record (e.g., all backend storage partitions will reach the same management result).

In one or more implementations, when comparing metadata instances for a data record, the distributed data system 106 determines that one or more attributes for a first instance of metadata are greater than the one or more attributes of corresponding attributes for a second instance of the metadata by at least a threshold amount. For example, if comparing timestamps for the most recent (e.g., newer) event, the distributed data system 106 adds a buffer threshold of x milliseconds, seconds, etc., to account for time skew, transmission delays, and processing delays. In alternative implementations, the distributed data system 106 does not utilize any type of buffer.

In additional and/or alternative implementations, the distributed data system 106 utilizes the e-tags of a data record to determine which backend storage partition manages a data record. For example, in various implementations, the e-tag provides one or more change markers that indicate when changes occur in a data record. In some implementations, the distributed data system 106 utilizes both the e-tag and the modification time to decide whether a backend storage partition manages a data record over another backend storage partition.

While the distributed data system 106 can compare timestamps and/or recency to determine who manages a data record, other comparison metrics may be used. For example, the distributed data system 106 compares a number of attributes, metadata size, metadata quality, and/or lifespan characteristics to determine which instance of metadata is more favorable (e.g., larger, longer, higher, and/or bigger (or vice versa)).

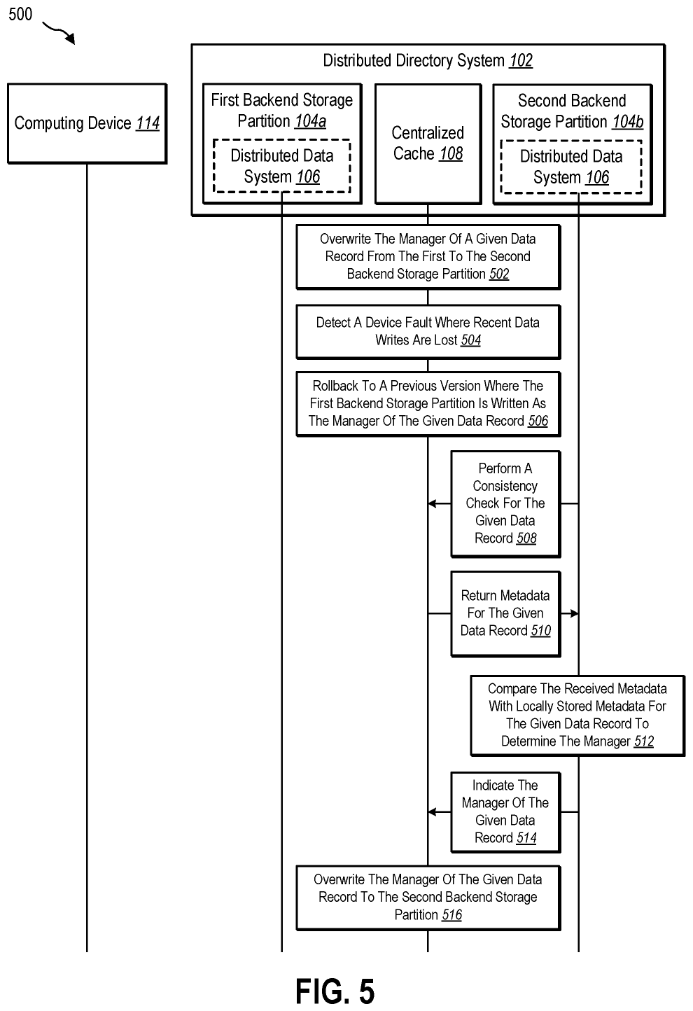

Turning to the next figure, FIG. 5 illustrates an example sequence diagram for implementing the distributed data system to resolve data conflicts between a centralized cache device and a backend storage partition in accordance with one or more implementations. As shown, FIG. 5 includes a series of acts 500 for the distributed data system 106 automatically correcting and self-healing a centralized cache after it has suffered a data loss.

To illustrate, the series of acts 500 includes an act 502 of the centralized cache 108 overriding the manager (e.g., management) of a data record from the first backend storage partition 104a to the second backend storage partition 104b. For example, as described above, the data record moves from the first backend storage partition 104a to the second backend storage partition 104b, and the second backend storage partition 104b provides an indication and/or updated metadata to the centralized cache 108 to indicate that the second backend storage partition 104b now manages the data record. In response, the centralized cache 108 updates the management for the data record in the data record mapping table.

Additionally, the series of acts 500 includes an act 504 of the centralized cache 108 detecting a device fault where recent data writes were lost. For example, the centralized cache 108 experiences a read or write device fault, upgrade error, connection loss, or another type of error. As a result, the centralized cache 108 rolls back to a previous version (e.g., based on the last full or partial device snapshot), as shown in the act 506 of the series of acts 500. In this previous version or state, the centralized cache 108 again indicates that the first backend storage partition 104a manages the data record (e.g., the device snapshot was taken before the act 502 occurred).

Due to the rollback, the data records 108a now include stale or incorrect information regarding device records. With existing computing systems, the rollback would create lost data that could not be recovered without manually examining activity logs and tediously correcting the latest data writes. Further, until the centralized directory server can be corrected, a data query for any data records that were recently changed at the centralized directory server will fail. In contrast, the distributed data system 106 automatically remedies and corrects such losses at the centralized cache 108.

To elaborate, after the rollback at the centralized cache 108 occurs, each backend storage partition continues to perform consistency checks against their active data records to ensure that the centralized cache 108 is storing the correct data record metadata. When a discrepancy is identified, the backend storage partition that manages a data record will push the correction to the centralized cache 108 so that it has the most current and correct information.

To illustrate, the series of acts 500 includes an act 508 of the second backend storage partition 104b performing a consistency check for the data record. As described above, because the second backend storage partition 104b manages the data record, it is responsible for continually ensuring that the centralized cache 108 has the correct management status and metadata of the data record (and all of its other active data records). Accordingly, after the rollback of the centralized cache 108 occurs, the second backend storage partition 104b will perform one or more consistent checks on the data records it manages.

As shown in FIG. 5, the series of acts 500 includes an act 510 of the centralized cache 108 returning (prior) metadata for a data record. Indeed, as described above, the centralized cache 108 indicates that the first backend storage partition 104a manages the data record or indicates that the second backend storage partition 104b does not manage the data record. Additionally, or as an alternative, the centralized cache 108 provides its stored metadata of the data record, which is rollback-based metadata of the given data received from the first backend storage partition 104a before the centralized cache 108 received and stored the updated metadata from the second backend storage partition 104b.

As also shown, the series of acts 500 includes an act 512 of the distributed data system 106 on the second backend storage partition 104b comparing the received metadata with locally stored metadata of the data record to determine the manager. As described above, the distributed data system 106 compares the two instances of metadata (or one or more attributes of the metadata instances) to determine which instance is correct and, thus, which backend storage partition correctly manages the data record.

In this example, based on the comparison, the second backend storage partition 104b determines that it is the correct current manager of the data record. For example, the distributed data system 106 determines that the second backend storage partition 104b has metadata of the data record (e.g., locally stored metadata) that is more recent (e.g., newer) than the metadata provided by the centralized cache 108.

Accordingly, in many implementations, the second backend storage partition 104b indicates the manager of the data record to the centralized cache 108, as shown in the act 514 of the series of acts 500. For example, the second backend storage partition 104b sends an indication of the manager of the data record and/or resends the updated metadata (or a portion of metadata) to the centralized cache 108. In a few implementations, the second backend storage partition 104b determines not to correct the management status for a period of time (e.g., pause the management correction indication), such as until the data record next changes.

As shown, the series of acts 500 includes an act 516 of the centralized cache 108 again overriding the manager of the data record to the second backend storage partition 104b. Thus, the distributed data system 106 on the second backend storage partition 104b (and the other backend storage partitions) will automatically self-heal the centralized cache 108, even in the event of a rollback or device failure. Indeed, if the centralized cache 108 completely fails with no backup and/or needs to be regenerated from the ground up, the distributed data system 106 will fully, accurately, and reliably restore the centralized cache 108. This is possible because the backend storage partitions manage the data records and are responsible for automatically and continuously providing the necessary metadata of the data records to the centralized cache 108.

Notably, the first backend storage partition 104a is not shown as providing a consistent check for the data record in the series of acts 500. Because the first backend storage partition 104a does not actively manage the data record, in many implementations, the first backend storage partition 104a will not send a consistent check to check on its management status. If the first backend storage partition 104a did send a consistent check, the result would be the same as described above in FIG. 4B with respect to the acts 432-438. Additionally, in some implementations, each backend storage partition can provide a consistent check for both active and inactive data records.

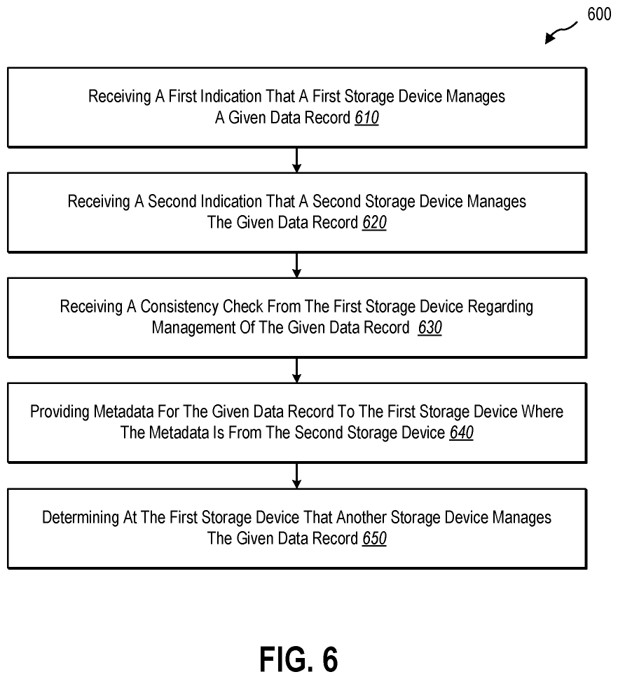

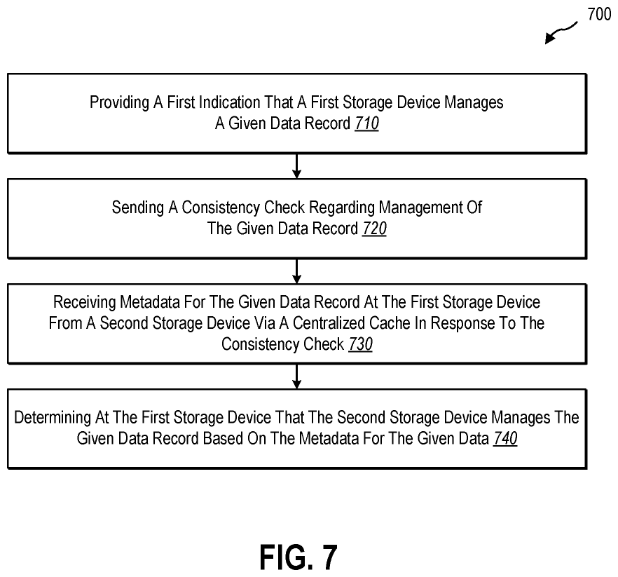

Turning now to FIG. 6 and FIG. 7, these figures each illustrates an example flowchart that includes a series of acts for utilizing the distributed data system 106 in accordance with one or more implementations. In particular, FIG. 6 and FIG. 7 each illustrates a series of acts for efficiently managing data records in a distributed directory system based on distributed backend storage partition devices in accordance with one or more implementations. In general, FIG. 6 is based on the perspective of a centralized cache while FIG. 7 is based on the perspective of a backend storage partition.

While FIG. 6 and FIG. 7 each illustrates acts according to one or more implementations, alternative implementations may omit, add to, reorder, and/or modify any of the acts shown. Further, the acts of FIG. 6 and FIG. 7 each can be performed as part of a method or a set of methods. Alternatively, a non-transitory computer-readable medium can include instructions that, when executed by at least one processor, cause a computing device to perform the acts of FIG. 6 and FIG. 7. In still further implementations, a system can perform the acts of FIG. 6 and FIG. 7.

As shown, the series of acts 600 includes an act 610 of receiving a first indication that a first storage device manages a data record. For instance, the act 610 may involve receiving, at a centralized cache device in a distributed data system, a first indication from a first backend storage partition device that the first backend storage partition device manages a given data record.

In one or more implementations, the act 610 includes creating, by the first backend storage partition device, the given data record; providing local metadata of the given data record to the centralized cache device; and writing, at the centralized cache device (e.g., at the data record mapping table), the first backend storage partition device as the manager or managing storage partition of the given data record in response to receiving the local metadata from the first backend storage partition device. In some implementations, the act 610 includes receiving, at the centralized cache device, metadata for a given data record from the first backend storage partition device and updating a data record mapping table at the centralized cache device to indicate the first backend storage partition device as the manager or managing storage partition of the given data record in response to receiving the metadata.

As further shown, the series of acts 600 includes an act 620 of receiving a second indication that a second storage device manages the given data record. For example, the act 620 may involve receiving, at the centralized cache device, a second indication from a second backend storage partition device that the second backend storage partition device manages the given data record. In various implementations, the second indication is received at the centralized cache after the first indication is received.

In one or more implementations, the act 620 includes, prior to the second indication, moving the given data record from the first backend storage partition device to the second backend storage partition device; sending or providing the metadata of the given data record to the centralized cache device from the second backend storage partition device based on moving the given data record to the second backend storage partition device and before the centralized cache device receives the consistency check from the first backend storage partition device; and updating the metadata of the given data record and writing the second backend storage partition device as the manager of the given data record in response to receiving the metadata from the second backend storage partition device. In some implementations, the act 620 also includes sending the centralized cache device with updated timestamps of the metadata of the given data record as part of sending the metadata of the given data record by the second backend storage partition device.

As further shown, the series of acts 600 includes an act 630 of receiving a consistency check from the first storage device regarding management of the data record. For example, the act 630 may include receiving, at the centralized cache device, a consistency check from the first backend storage partition device regarding the management status of the given data record. In various implementations, the act 630 includes the first backend storage partition device verifying the management status of the given data record by sending a request to the centralized cache device for metadata of the given data record being currently stored at the centralized cache device and verifying whether the first backend storage partition device currently manages the given data record based on comparing the metadata of the given data record from the centralized cache device to metadata for the given data record stored locally at the first backend storage partition device.

As further shown, the series of acts 600 includes an act 640 of providing metadata of the data record to the first storage device where the metadata is from the second storage device. For example, the act 640 may involve in response to receiving the consistency check, providing metadata of the given data record from the centralized cache device to the first backend storage partition device, where the metadata was sent to the centralized cache device from the second backend storage partition device.

As further shown, the series of acts 600 includes an act 650 of determining at the first storage device that another storage device manages the data record. For example, the act 650 may include determining, at the first backend storage partition device, that another backend storage partition device (e.g., the second backend storage partition device) manages the given data record based on comparing the metadata of the given data record received from the centralized cache device to local metadata of the given data record stored at the first backend storage partition device.

In one or more implementations, the act 650 includes comparing the metadata of the given data record to the local metadata of the given data record by comparing timestamps between the metadata of the given data record and the local metadata. In some implementations, the act 650 includes the first backend storage partition device determining that the second backend storage partition device manages the given data record when a first timestamp for the metadata of the given data record is newer by at least a threshold time than a second timestamp for the local metadata of the given data record.

In some implementations, the series of acts 600 includes additional acts. For example, in certain implementations, the series of acts 600 includes the acts of receiving, at the centralized cache device, a query from a computing device requesting information associated with the given data record; determining, by the centralized cache device, that the second backend storage partition device is the manager of the given data record based on the given data record being associated with the second backend storage partition device in a data record mapping table; and directing the query to the second backend storage partition device for the fulfillment of the query in response to the query. In various implementations, the series of acts 600 includes the act of directing the query to the first backend storage partition device for the fulfillment of the query in response to receiving a query from a computing device requesting information associated with the given data record (e.g., prior to the given data record being moved).

In one or more implementations, the series of acts 600 includes the acts of rolling back or reverting the centralized cache device to a previous state where the given data record is owned by the second backend storage partition device in response to detecting, at the centralized cache device, a device fault; receiving, from the first backend storage partition device and to the centralized cache device, a consistency check regarding the management status of the given data record; and indicating to the first backend storage partition device by the centralized cache device that the second backend storage partition device manages the given data record in response to receiving the consistency check.

Turning now to FIG. 7, as shown, the series of acts 700 includes an act 710 of providing a first indication that a first storage device manages a data record. For instance, the act 710 may involve providing, from a first backend storage partition device in a distributed data system and to a centralized cache device in the distributed data system, a first indication that the first backend storage partition device manages a given data record. In one or more implementations, the act 710 includes moving the given data record from the first backend storage partition device to the second backend storage partition device after providing the first indication and/or providing the metadata of the given data record to the centralized cache device from the second backend storage partition device in response to the consistency check.

As further shown, the series of acts 700 includes an act 720 of sending a consistency check regarding management of the data record. For example, the act 720 may involve sending, from the first backend storage partition device and to the centralized cache device, a consistency check regarding the management status of the given data record. In various implementations, the act 720 includes periodically scanning, by the first backend storage partition device, active data records stored on the first backend storage partition device and providing consistency checks to the centralized cache device regarding the management status of its active data records.

In some implementations, the act 720 includes detecting, at the first backend storage partition device, a device fault after moving the given data record to the second backend storage partition device and before the consistency check is sent; rolling back the first backend storage partition device to a previous state where the given data record is stored on the first backend storage partition device in response to the device fault; sending, from the first backend storage partition device and to the centralized cache device, the consistency check regarding management status of the given data record; and in response to receiving the metadata of the given data record at the first backend storage partition device and from the centralized cache device, determining, at the first backend storage partition device, that the centralized cache device indicates that the second backend storage partition device manages the given data record.

As further shown, the series of acts 700 includes an act 730 of receiving metadata of the data record at the first storage device from a second storage device via a centralized cache in response to the consistency check. For example, the act 730 may include receiving, at the first backend storage partition device and from the centralized cache device, metadata of the given data record provided to the centralized cache device from a second backend storage partition device in response to the consistency check.

As further shown, the series of acts 700 includes an act 740 of determining at the first storage device that the second storage device manages the data record based on the metadata of the given data. For example, the act 740 may involve determining, at the first backend storage partition device, that the second backend storage partition device manages the given data record based on the metadata of the given data record received from the centralized cache device. In certain implementations, the act 740 includes unmanaging (e.g., marking as inactive, removing, ignoring, closing out, or overwriting) the given data record at the first backend storage partition device in response to determining that the second backend storage partition device manages the given data record. In one or more implementations, the act 740 includes automatically resolving management at the first backend storage partition device by determining, at the first backend storage partition device, that the second backend storage partition device manages the given data record based on the metadata of the given data record received from the centralized cache device and/or updating the first backend storage partition device to mark the given data record as inactive.

In some implementations, the series of acts 700 includes additional acts. For example, in certain implementations, the series of acts 700 includes the acts of receiving, at the first backend storage partition device and from the centralized cache device, additional metadata for an additional data record, wherein the additional metadata indicates that the centralized cache device has written the second backend storage partition device as the manager of the additional data record; comparing, by the first backend storage partition device, the additional metadata for an additional data record to local metadata of the additional data record stored on the first backend storage partition device to determine that the local metadata of the additional data record is newer; and providing the local metadata and/or an indication to the centralized cache device that indicates the first backend storage partition device as manager of the additional data record in response to the comparison of the additional metadata for an additional data record to local metadata of the additional data record stored on the first backend storage partition device.

In some implementations, the series of acts 700 includes the acts of generating the centralized cache device to indicate storage locations and management of each of the data records across the distributed data system by receiving consistency checks for the first plurality of data records from the first backend storage partition device and from the second backend storage partition device for the second plurality of data records and generating the given data record mapping table at the centralized cache device to indicate that the first backend storage partition device manages the first plurality of data records and that the second backend storage partition device manages the second plurality of data records based on receiving the consistency checks from the first backend storage partition device and the second backend storage partition device.

In various implementations, the series of acts 700 includes the acts of later determining, at the second backend storage partition device, that the second backend storage partition device manages the given data record and, in response, sending, from the second backend storage partition device to the centralized cache device, updated metadata that indicates the second backend storage partition device as the manager of the given data record. In some implementations, the series of acts 700 includes determining that the second backend storage partition device manages the given data record by comparing, at the second backend storage partition device, metadata of the given data record from the first backend storage partition device via the centralized cache device to local metadata of the given data record to determine that the local metadata of the given data record at the second backend storage partition device is more recent (e.g., newer).

A “computer network” (hereinafter “network”) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry needed program code means in the form of computer-executable instructions or data structures and which can be accessed by a general-purpose or special-purpose computer. Combinations of the above should also be included within the scope of computer-readable media.

In addition, the network (e.g., computer network) described herein may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the distributed data system 106. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network (e.g., computer network) or data link can be buffered in RAM within a network interface module (NIC), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions include, for example, instructions and data that, when executed by at least one processor, cause a general-purpose computer, special purpose computer, or special purpose processing device to perform a certain function or group of functions. In some implementations, computer-executable instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

FIG. 8 illustrates certain components that may be included within a computer system 800. The computer system 800 may be used to implement the various computing devices, components, and systems described herein.

In various implementations, the computer system 800 may represent one or more of the client devices, server devices, or other computing devices described above. For example, the computer system 800 may refer to various types of network devices capable of accessing data on a network (e.g., a computer network), a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 800 includes a processor 801 (e.g., at least one processor). The processor 801 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although the processor 801 shown is just a single processor in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 805 and the data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during the execution of the instructions 805 by the processor 801.

A computer system 800 may also include one or more communication interface(s) 809 for communicating with other electronic devices. The one or more communication interface(s) 809 may be based on wired communication technology, wireless communication technology, or both. Some examples of the one or more communication interface(s) 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 800 may also include one or more input device(s) 811 and one or more output device(s) 813. Some examples of the one or more input device(s) 811 include a keyboard, mouse, microphone, remote control device, button, joystick, trackball, touchpad, and light pen. Some examples of the one or more output device(s) 813 include a speaker and a printer. A specific type of output device that is typically included in a computer system 800 is a display device 815. The display device 815 used with implementations disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network (e.g., computer network), both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium including instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can include at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid-state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is therefore indicated by the appended claims rather than by the foregoing description. Changes that come within the meaning and range of equivalency of the claims are to be embraced within their scope.

What is claimed is:

1. A computer-implemented method comprising:
receiving, at a centralized cache device in a distributed data system, a first indication from a first backend storage partition device that the first backend storage partition device manages a given data record;
receiving, at the centralized cache device, a second indication from a second backend storage partition device that the second backend storage partition device manages the given data record;
receiving, at the centralized cache device, a consistency check from the first backend storage partition device regarding management status of the given data record; and
in response to receiving the consistency check, providing metadata of the given data record from the centralized cache device to the first backend storage partition device, where the metadata was sent to the centralized cache device from the second backend storage partition device.

2. The computer-implemented method of claim 1, wherein providing the metadata of the given data record to the first backend storage partition device causes the first backend storage device to determine that another backend storage partition device manages the given data record based on comparing the metadata of the given data record received from the centralized cache device to local metadata of the given data record stored at the first backend storage partition device.

3. The computer-implemented method of claim 2, wherein comparing the metadata of the given data record to the local metadata of the given data record comprises comparing timestamps between the metadata of the given data record and the local metadata.

4. The computer-implemented method of claim 3, wherein the first backend storage partition device determines that the second backend storage partition device manages the given data record when a first timestamp of the metadata associated with the given data record is newer by at least a threshold time than a second timestamp of the local metadata associated with the given data record.

5. The computer-implemented method of claim 1, wherein the consistency check comprises the first backend storage partition device verifying the management status of the given data record by:
sending a request to the centralized cache device for metadata of the given data record being currently stored at the centralized cache device; and
verifying whether the first backend storage partition device currently manages the given data record based on comparing the metadata of the given data record from the centralized cache device to metadata for the given data record stored locally at the first backend storage partition device.

6. The computer-implemented method of claim 1, further comprising:
receiving, from the first backend storage partition device, local metadata of the given data record created by the first backend storage partition device; and
in response to receiving the local metadata from the first backend storage partition device, writing, at the centralized cache device, the first backend storage partition device as manager of the given data record.

7. The computer-implemented method of claim 1, wherein the given data record from the first backend storage partition device is moved to the second backend storage partition device, and wherein the method further comprises:
receiving the metadata of the given data record from the second backend storage partition device, the metadata being based on the given data record moving from the first backend storage partition device to the second backend storage partition device; and
in response to receiving the metadata from the second backend storage partition device, updating the metadata of the given data record and writing the second backend storage partition device as manager of the given data record.

8. The computer-implemented method of claim 7, wherein the metadata is received in connection with updated timestamps of the given data record.

9. The computer-implemented method of claim 1, further comprising:
receiving, at the centralized cache device, a query from a computing device requesting information associated with the given data record;
determining, by the centralized cache device, that the second backend storage partition device is manager of the given data record based on the given data record being associated with the second backend storage partition device in a data record mapping table; and
in response to the query, directing the query to the second backend storage partition device for fulfillment of the query.

10. A computer-implemented method comprising:
providing, from a first backend storage partition device in a distributed data system and to a centralized cache device in the distributed data system, a first indication that the first backend storage partition device manages a given data record;
sending, from the first backend storage partition device and to the centralized cache device, a consistency check regarding management status of the given data record;
in response to the consistency check, receiving, at the first backend storage partition device and from the centralized cache device, metadata of the given data record provided to the centralized cache device from a second backend storage partition device;
determining, at the first backend storage partition device, that the second backend storage partition device manages the given data record based on the metadata of the given data record received from the centralized cache device; and
unmanaging the given data record at the first backend storage partition device.

11. The computer-implemented method of claim 10, further comprising moving the given data record from the first backend storage partition device to the second backend storage partition device.

12. The computer-implemented method of claim 11, further comprising:
after moving the given data record to the second backend storage partition device, detecting, at the first backend storage partition device, a device fault;
in response to the device fault, rolling back the first backend storage partition device to a previous state where the given data record is stored on the first backend storage partition device;
sending, from the first backend storage partition device and to the centralized cache device, the consistency check regarding management status of the given data record; and
in response to receiving the metadata of the given data record at the first backend storage partition device and from the centralized cache device, determining, at the first backend storage partition device, that the centralized cache device indicates that the second backend storage partition device manages the given data record.

13. The computer-implemented method of claim 12, further comprising:
automatically resolving management at the first backend storage partition device by determining, at the first backend storage partition device, that the second backend storage partition device manages the given data record based on the metadata of the given data record received from the centralized cache device; and
updating the first backend storage partition device to mark the given data record as inactive.

14. The computer-implemented method of claim 10, further comprising:
periodically scanning, by the first backend storage partition device, active data records stored on the first backend storage partition device; and
providing consistency checks to the centralized cache device regarding management status of the active data records.

15. The computer-implemented method of claim 10, further comprising:
receiving, at the first backend storage partition device and from the centralized cache device, additional metadata for an additional data record, wherein the additional metadata indicates that the centralized cache device has written the second backend storage partition device as manager of the additional data record;
comparing, by the first backend storage partition device, the additional metadata for an additional data record to local metadata of the additional data record stored on the first backend storage partition device to determine that the local metadata of the additional data record is newer; and
in response to comparing the additional metadata to the local metadata, providing the local metadata and an indication to the centralized cache device that indicates the first backend storage partition device as manager of the additional data record.

16. A distributed data system comprising:
a centralized cache device that stores metadata for data records; and
a first backend storage partition device that manages and stores a first plurality of data records,
wherein the distributed data system performs acts of:
receiving, at the centralized cache device, metadata for a given data record of the first plurality of data records from the first backend storage partition device;
in response to receiving the metadata, updating a data record mapping table at the centralized cache device to indicate the first backend storage partition device as manager of the given data record; and
in response to receiving a query from a computing device requesting information associated with the given data record, directing the query to the first backend storage partition device for fulfillment of the query.

17. The distributed data system of claim 16, the distributed data system further comprising a second backend storage partition device that manages and stores a second plurality of data records;
wherein the distributed data system further performs the acts of:
in response to detecting, at the centralized cache device, a device fault, rolling back the centralized cache device to a previous state where the given data record is owned by the second backend storage partition device;
receiving, from the first backend storage partition device and to the centralized cache device, a consistency check regarding management status of the given data record; and
in response to receiving the consistency check, indicating to the first backend storage partition device by the centralized cache device that the second backend storage partition device manages the given data record.

18. The distributed data system of claim 17, wherein the distributed data system further performs the acts of:
determining, at the first backend storage partition device, that the first backend storage partition device manages the given data record; and
in response, sending, from the first backend storage partition device to the centralized cache device, updated metadata that indicates the first backend storage partition device as manager of the given data record.

19. The distributed data system of claim 17, wherein determining that the first backend storage partition device manages the given data record comprises comparing, at the first backend storage partition device, metadata of the given data record from the second backend storage partition device via the centralized cache device to local metadata of the given data record to determine that the local metadata of the given data record is more recent.

20. The distributed data system of claim 16, the distributed data system further comprising a second backend storage partition device that manages and stores a second plurality of data records;
wherein the distributed data system further performs the acts of generating the centralized cache device to indicate storage locations and management of each data record across the distributed data system by:
receiving consistency checks for the first plurality of data records from the first backend storage partition device and from the second backend storage partition device for the second plurality of data records; and
based on receiving the consistency checks from the first backend storage partition device and the second backend storage partition device, generating the data record mapping table at the centralized cache device to indicate that the first backend storage partition device manages the first plurality of data records and that the second backend storage partition device manages the second plurality of data records.
